(19) United States
(12) Patent Application Publication
(10) Pub. No.: US 2024/0078261 A1
(43) Pub. Date: Mar. 7, 2024

(54) HYBRID SAMPLING FOR A GENERAL-PURPOSE TEMPORAL GRAPH RANDOM WALK ENGINE

(71) Applicant: Tsinghua University, Beijing (CN)

(72) Inventors: Yongwei Wu, Beijing (CN); Jinlei Jiang, Beijing (CN); Kang Chen, Beijing (CN); Chengying Huan, Beijing (CN)

(21) Appl. No.: 17/902,227

(22) Filed: Sep. 2, 2022

(51) Int. Cl. G06F 16/901; G06F 16/23; H04L 43/06

(52) U.S. Cl. CPC G06F 16/9024; G06F 16/2322; H04L 43/06

(57) ABSTRACT

Systems and methods are provided for performing temporal graph computing. One method may include ordering out edges in a candidate edge set of a vertex in deceasing time, grouping the out edges into a plurality of trunks with at least one of the plurality of trunks being a multi-edge trunk having two or more edges, generating a plurality of alias tables to record content of the plurality of trunks, performing inverse transform sampling on the plurality of trunks to choose a first trunk of interest, determining that the first trunk of interest is a complete multi-edge trunk with a plurality of edges arranged in a plurality of buckets and each bucket has an average weight of a total weight of the plurality of edges and sampling an edge from the plurality of edges by alias table sampling.

### TECHNICAL FIELD

The disclosure herein relates to graph computing, particularly relates to sampling edges for random walk graph computing of temporal graphs that have timing information attached to edges.

### BACKGROUND

Graph computing is widely used in a large number of applications. Many real-world applications are inherently temporal graphs, where the temporal information indicates when a particular edge is changed (e.g., edge insertion and deletion). Random walk is a popular and fundamental tool for many graph applications like graph processing, link prediction, graph mining, graph embedding, and node classification. In general, a random walk usually starts by a walker from a specific vertex. At each step, this walker samples an edge from the outgoing neighbors of its currently residing vertex according to the transition probability defined by each random walk application. This process will continue until it meets certain termination criteria, such as the walker has walked a predetermined length of the random walk.

Given the importance of temporal information, integrating temporal information into random walk can drastically improve the graph learning accuracy, reflecting the growing importance of temporal random walks. However, different from that on a static graph, a temporal graph walker must guarantee that the time order of a path increases. Specifically, a temporal graph walker starts from a specific vertex. At each step, this walker samples an edge from the out edges of its currently residing vertex that has a larger time instance than the in edge according to the transition probability used. As known in the graph computing field, in static graphs, the edge sampling efficiency determines the performance of a random walk algorithm. When it comes to temporal graphs, the additional temporal information will, unfortunately, complicate the sampling process.

Rejection sampling is often regarded as one of the most suitable sampling algorithms for dynamic random walks. But it suffers from a high rejection rate in temporal random walks. Alias method for sampling offers better sampling complexity over inverse transform sampling (ITS). Unfortunately, the dynamically evolving candidate edge set introduces gigantic space consumption in the alias method. Particularly, because temporal random walk requires the path to obey the time order, different walkers might need different candidate edge sets even when they are sampling the same vertex. In this context, the alias method requires constructing various versions of alias tables prior to execution to avoid high time consumption costs. This will lead to enormous space consumption and cause high sampling complexity as the correct version of the alias table for sampling have to be identified based on the temporal information of the current arriving edge.

Moreover, there lacks a general-purpose framework that can provide both necessary algorithmic and system-level supports and optimizations for enabling efficient random walks on temporal graphs. This results in poor user productivity and low-performance implementations of these types of algorithms and applications. Additionally, it is counter-intuitive for users to implement these walker-centric algorithms in popular graph frameworks because they can easily lose the ability to track the walker state updates. Adding another dimension of temporal information to random walk further complicates the programmability. Particularly, it would be extremely challenging for the users to manage the dynamically changing sampling space, as well as derive the optimal Monte Carlo sampling method for temporal random walk algorithms.

Accordingly, there is a need for a sampling method that addresses concerns of existing sampling methods and also a need for a highly-efficient general-purpose temporal graph random walk engine.

### SUMMARY

The present disclosure provides systems and methods for sampling processes in temporal graph random walk computing and a highly-efficient general-purpose temporal graph random walk engine. Embodiments of the present disclosure provide a new hybrid sampling approach that combines two Monte Carlo sampling methods together to drastically reduce the space complexity and achieve high sampling speed. Moreover, various embodiments may further employ one or more algorithmic and system-level optimizations to improve the sampling efficiency, as well as provide support for streaming graphs. In addition, a temporal-centric programming model to ease the implementation of various random walk algorithms on temporal graphs is provided.

In an exemplary embodiment, there is provided a method for performing temporal graph computing that may comprise ordering out edges in a candidate edge set of a vertex in deceasing time, grouping the out edges into a plurality of trunks with at least one of the plurality of trunks being a multi-edge trunk having two or more edges, generating a plurality of alias tables to record content of the plurality of trunks, performing inverse transform sampling on the plurality of trunks to choose a first trunk of interest, determining that the first trunk of interest is a complete multi-edge trunk with a plurality of edges arranged in a plurality of buckets and sampling an edge from the plurality of edges in the complete multi-edge trunk by alias table sampling on an alias table of the plurality of alias tables corresponding to the first trunk of interest. Each bucket may have an average weight of a total weight of the plurality of edges.

In another exemplary embodiment, there is provided a computing system that may comprise a main memory for storing software instructions for performing temporal graph computing and a central processing unit (CPU) coupled to the main memory and configured to execute the software instructions to: order out edges in a candidate edge set of a vertex in deceasing time, group the out edges into a plurality of trunks with at least one of the plurality of trunks being a multi-edge trunk having two or more edges, generate a plurality of alias tables to record content of the plurality of trunks, perform inverse transform sampling on the plurality of trunks to choose a first trunk of interest, determine that the first trunk of interest is a complete multi-edge trunk with a plurality of edges arranged in a plurality of buckets and each bucket has an average weight of a total weight of the plurality of edges, and sample an edge from the plurality of edges in the complete multi-edge trunk by alias table sampling on an alias table of the plurality of alias tables corresponding to the first trunk of interest.

In yet another exemplary embodiment, there is provided one or more computer-readable non-transitory media comprising one or more instructions that when executed by one or more processors is to configure the one or more processors to perform operations comprising: ordering out edges in a candidate edge set of a vertex in deceasing time, grouping the out edges into a plurality of trunks with at least one of the plurality of trunks being a multi-edge trunk having two or more edges, generating a plurality of alias tables to record content of the plurality of trunks, performing inverse transform sampling on the plurality of trunks to choose a first trunk of interest, determining that the first trunk of interest is a complete multi-edge trunk with a plurality of edges arranged in a plurality of buckets and each bucket has an average weight of a total weight of the plurality of edges, and sampling an edge from the plurality of edges in the complete multi-edge trunk by alias table sampling on an alias table of the plurality of alias tables corresponding to the first trunk of interest.

### BRIEF DESCRIPTION OF FIGURES

FIG. 1 schematically shows a temporal graph for a random walk application in accordance with an embodiment of the present disclosure.

FIG. 2A schematically shows edges of a candidate edge set arranged into trunks in accordance with an embodiment of the present disclosure.

FIG. 2B schematically shows a persistent alias table in accordance with an embodiment of the present disclosure.

FIG. 3A schematically shows hierarchical grouping of edges into trunks in accordance with an embodiment of the present disclosure.

FIG. 3B schematically shows a hierarchical persistent alias table in accordance with an embodiment of the present disclosure.

FIG. 3C schematically shows another hierarchical persistent alias table in accordance with an embodiment of the present disclosure.

FIG. 3D schematically shows an auxiliary index in accordance with an embodiment of the present disclosure.

FIG. 4A schematically shows new edges being added to a candidate edge set in accordance with an embodiment of the present disclosure.

FIG. 4B schematically shows a new trunk in a higher order in a hierarchy with new edges added to the candidate edge set in accordance with an embodiment of the present disclosure.

FIG. 5 shows a flow diagram for xxx in accordance with an embodiment of the present disclosure.

FIG. 6 shows a general computing device in accordance with an embodiment of the present disclosure.

### DETAILED DESCRIPTION

Specific embodiments according to the present disclosure will now be described in detail with reference to the accompanying figures. Like elements in the various figures are denoted by like reference numerals for consistency.

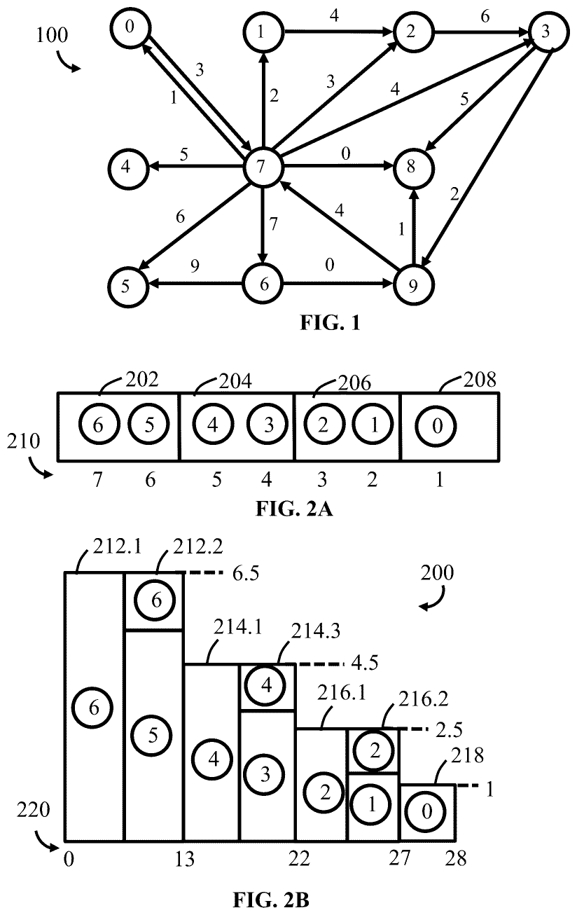

The present disclosure provides systems and methods for temporal graph computing. FIG. 1 schematically shows a temporal graph 100 for a random walk application in accordance with an embodiment of the present disclosure. The temporal graph 100 may include 10 vertices with indices 0, 1, 2, 3, 4, 5, 6, 7, 8 and 9, respectively. Each vertex may be shown as a circle with a vertex index inside the circle. There are a plurality of directional edges with temporal information in the temporal graph 100. For example, there is one edge from vertex 0 to vertex 7 with a time label of 3 and another edge from vertex 7 to vertex 0 with a time label of 1. A time label may also be referred to as a timestamp. If a path is to be formed over the graph 100, the path must obey the temporal connectivity rule. That is, passing through each vertex, a valid commuting path mush satisfy that the time of the out edge from this vertex is greater than that of the in edge. Using the paths arriving at vertex 7 from vertex 9 as an example, because the edge from vertex 9 to vertex 7 has a time of 4, only paths from vertex 7 to vertex 4 (e.g., a timestamp of 5), from vertex 7 to vertex 5 (e.g., a timestamp of 6) and from vertex 7 to vertex 6 (e.g., a timestamp of 7) are valid.

In some embodiments, the temporal graph 100 may be represented by a data model that may refer to a graph as G=(V, E, R) where E may be the edges set and V may be the vertices set, and R may be the temporal information set, which may have a size of |E|. An edge “e” of the edges set E may be denoted as a triplet (u, v, t), in which u and v may be vertices of the vertices set V, and t may represent the time that the edge appears and t∈R. The degree of each vertex v may be defined as and the maximum vertex degree may be defined as D=max {dᵥ, v∈V}. A path in the temporal graph may be called a temporal path, which may start from a vertex u₁ at time t₁ and arrives at vertex uₙ at time tₙ₋₁. Thus, this path may be defined as P=e₁·e₂· . . . eₙ₋₁ where eᵢ=(uᵢ, uᵢ₊₁, tᵢ) and it must satisfy the time constraint tᵢ₋₁<tᵢ with i>1. In various embodiments, the temporal graph 100 may be represented as an edge stream: a sequence of all edges that may come in the order of time each edge may be created or collected.

In various embodiments, a random walk computing task may follow a similar process: a group of walkers, each of which starts from a vertex in a graph (u), selects a neighbor of the current vertex (vᵢ) from candidate edge set N(u) (e.g., edge sampling step), and transits (or moves) to the selected neighbor. This process may continue until certain termination conditions are met. The neighbor of the current vertex for making the movement may be chosen based on a probability referred to as the edge transition probability, which may be defined as:

$$P ( ( u , {v}_{i} ) ) = \frac{δ ( ( u , {v}_{i} ) )}{{\sum }_{( u , {v}_{j} ) ∈ N ( u )} δ ( ( u , {v}_{j} ) )} ,$$

in which δ ((u, vᵢ)) is the weight of edge (u, vᵢ).

In different random walk applications, the edge weights may be defined differently. For example, in linear temporal weight random walk, the edge weight for one edge may be set as the time instance of the edge. That is, for an edge (u, vᵢ, tᵢ), the edge weight may be set as the timestamp tᵢ. As another example, in exponential temporal weight random walk, when a walker arrives at a vertex u at time t, the current edge set of u is N(u). The edge weight is set as δ((u, vᵢ, tᵢ) =exp(tᵢ−t), which is changing according to the current time instance t.

Using the temporal graph 100 as an example, the vertex 7 may have out edges (7, 0, 1), (7, 1, 2), (7, 2, 3), (7, 3, 4), (7, 4, 5), (7, 5, 6), (7, 6, 7). In linear temporal weight random walk, the edge weights for these edges may be 1, 2, 3, 4, 5, 6, 7, respectively.

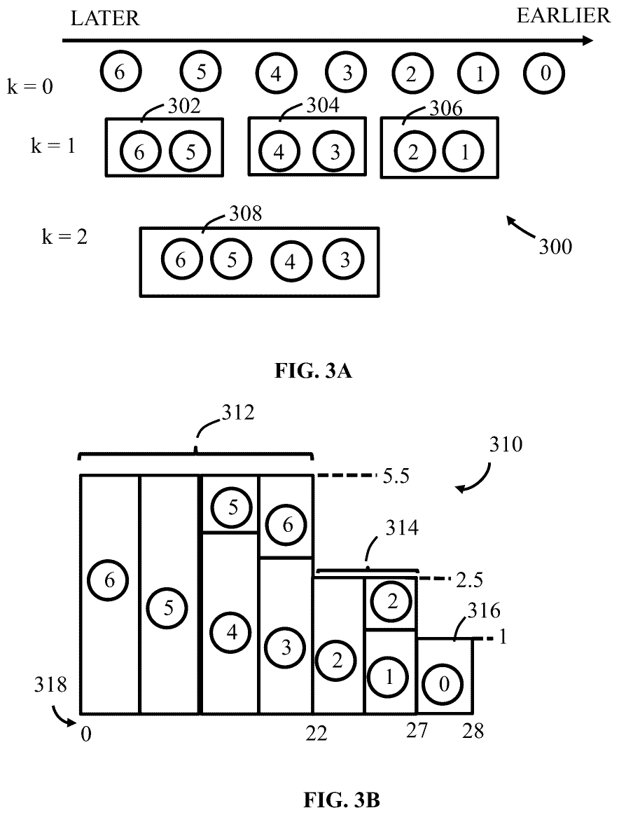

FIG. 2A schematically shows edges of a candidate edge set arranged into trunks in accordance with an embodiment of the present disclosure. Edge sampling is the predominant workload in random walk computation. Although the candidate edge set for an edge may change dynamically according to the temporal information in a temporal graph, the edge set may be a combination of several static trunks. Embodiments according to the present disclosure may partition a candidate edge set into a collection of trunks, where each trunk is static in the original graph. The list of neighbors of vertex 7 of the temporal graph 100 may be determined by out edges of the vertex 7 and may be represented as an edge set {6, 5, 4, 3, 2, 1, 0} with the edges ordered in decreasing time. These out edges may be partitioned into trunks 202, 204, 206 and 208, with edges to vertices 6 and 5 into trunk 202, edges to vertices 4 and 3 into trunks 204, edges to vertices 2 and 1 into trunks 206 and edges to vertices 0 into trunk 208. The four trunks 202, 204, 206 and 208 may be formed based on decreasing time, with trunks 202, 204 and 206 being multi-edge trunks. The weights of the edges in linear temporal weight random walk may be listed under the trunks in the temporal weight list 210. The temporal weight list 210 may indicate that the out edges of the candidate edge set are ordered in decreasing time.

FIG. 2B schematically shows a persistent alias table (PAT) 200 in the trunks in accordance with an embodiment of the present disclosure. The PAT 200 may be used to record the arrangement of temporal weights in the trunks. Inside each trunk, depending on the number n of edges in the trunk, the n edge(s) may be arranged into n buckets with each bucket having an average weight of the total edge weight in the trunk. Each trunk may also be represented by edges in the trunk as {edge 1, edge 2, edge 3, . . . }. For example, inside the trunk 202, there are two edges (7, 6) and (7, 5) with edge weight 7 and edge weight 6, respectively. The trunk 202 may be represented as {6, 5}. The total edge weight in the trunk 202 may be 13 and each bucket may have an average weight 6.5. As shown in FIG. 2B, a portion of the edge weight of the edge to vertex 6 may be transferred to the bucket 212.2 holding the edge weight of edge to vertex 5, so that the bucket 212.1 may hold a portion of the edge weight of the edge (7, 6) and the bucket 212.2 may hold the transferred portion of the edge weight of the edge (7, 6) and the whole edge weight of the edge (7, 5). The buckets 212.1 and 212.2 may also be recorded in one alias table for the trunk 202, which may be part of the PAT 200 for all out edges of the vertex 7.

Inside the trunk 204, two edges (7, 4) and (7, 3) may have edge weight 5 and 4, respectively. The trunk 204 may be represented as {4, 3}. The total edge weight in the trunk 204 may be 9 and each of the two buckets 214.1 and 214.2 may have an average weight of 4.5. A portion of the edge weight of the edge (7, 5) may be transferred to the bucket 214.2 holding the edge weight of the edge to vertex 4, so that the bucket 214.1 may hold a portion of the edge weight of the edge (7, 4) and the bucket 214.2 may hold the transferred portion of the edge weight of the edge (7, 4) and the whole edge weight of the edge (7, 3). The buckets 214.1 and 214.2 may recorded in one alias table for the trunk 204, which may also be part of the PAT 200.

Inside the trunk 206, two edges (7, 2) and (7, 1) may have edge weights 3 and 2, respectively. The trunk 206 may be represented as {2, 1}. The total edge weight in the trunk 202 may be 5 and each of the two buckets 216.1 and 216.2 may have an average weight of 2.5. A portion of the edge weight of the edge (7, 2) may be transferred to the bucket 216.2 holding the edge weight of the edge (7, 1), so that the bucket 216.1 may hold a portion of the edge weight of the edge (7, 2) and the bucket 216.2 may hold the transferred portion of the edge weight of the edge (7, 2) and the whole edge weight of the edge (7, 1). The buckets 216.1 and 216.2 may also be recorded in one alias table for the trunk 206, which may also be part of the PAT 200. Inside the trunk 208, there is only one edge (7, 0) with edge weight 1. The trunk 208 may be represented as {0}. The total edge weight in the trunk 208 may be 1 and a single bucket 218 may have edge weight 1. The buckets 218 may be recorded in one alias table for the trunk 208, which may also be part of the PAT 200.

For each vertex u, an array C may be used to store the Cumulative Distribution Function by calculating the prefix sum of the weights of the current edge set N(u). In the array C, each element may be the cumulative weights of the edges weights up to the current edge. For N(u)={e₁, e₂, . . . eₙ}, assume the weight of each edge eᵢ is W(eᵢ), C[i]=Σⱼ₌₁ⁱW(eⱼ). As an example, the prefix sum array 220 {0, 13, 22, 27, 28} for the trunks 202, 204, 206 and 208 may be shown at the bottom of FIG. 2B.

During sampling, a trunk of interest may be chosen by inverse transform sampling (ITS), in which a random number r may be generated in the range [0,C[|N(u)|]], where C[|N(u)|] is the sum of all the edges' weights in N(u), and the trunk of interest may be sampled by determining which trunk the random number falls into.

There may be two situations for sampling an edge in the trunk of interest depending on the candidate edge set. In a first situation, the candidate edge set contain no partial trunks. That is, the candidate edges form complete trunks. For example, for an incoming edge (0, 7, 3), the candidate edge set is {6, 5, 4, 3}, with {6, 5} forming one complete trunk and {4, 3} forming another complete trunk. In this situation, the trunk of interest may be sampled by inverse transform sampling, during which a random number in the range of [0, 22] may be generated. If the random number falls into the range of [0, 13], the trunk {6, 5} may be sampled as the trunk of interest; if the random number falls into the range (13, 22] (e.g., exclusive of 13 and inclusive of 22), the trunk {4, 3} may be sampled as the trunk of interest. In either case, the edge in the trunk of interest may be sampled by alias table sampling. In alias table sampling, because each bucket has an equal weight, a bucket may be sampled by uniform sampling, and then an edge in the sampled bucket may be sampled based on the proportion of the edge's weight to the sum of the edge weights in the bucket.

In a second situation, the candidate edge set may contain a partial trunk. For example, for an incoming edge (9, 7, 4), the candidate edge set is {6, 5, 4}, with {6, 5} forming one complete trunk and {4} forming an incomplete trunk (e.g., half of the trunk {4, 3}). In this situation, the total weight of the valid candidate edges is 7+6+5=18, and a random number in the range of the [0, 18] may be generated. If the random number falls into the range of [0, 13], then the complete trunk {6, 5} may be chosen as the trunk of interest and an edge in this trunk may be sampled as in the first situation (e.g., by alias table sampling). If the random number falls into the range of (13, 18], the incomplete trunk may be the trunk of interest and a prefix sum for this incomplete trunk (e.g., 18) needs to be built. Because in the incomplete trunk there may be only prefix sums and no buckets with average weight, the edge in the incomplete trunk may be sampled based on edges' weight (e.g., inverse transform sampling).

PAT sampling may alleviate the drawbacks of either the alias table and ITS used alone. First, comparing to the alias sampling, for each vertex u, the space consumption may be reduced from O(D²)) to O(D), where D is the degree of vertex u. The persistent alias table sampling may take only O(D) space because both the trunks and prefix sum of trunks take O(D) space. Second, compared to ITS, the PAT sampling may reduce the search time complexity from O(logD) to

$$O ( log \frac{D}{trunkSize} ) ,$$

in which trunkSize may be the size of the trunk (e.g., 2 edges for FIG. 2A).

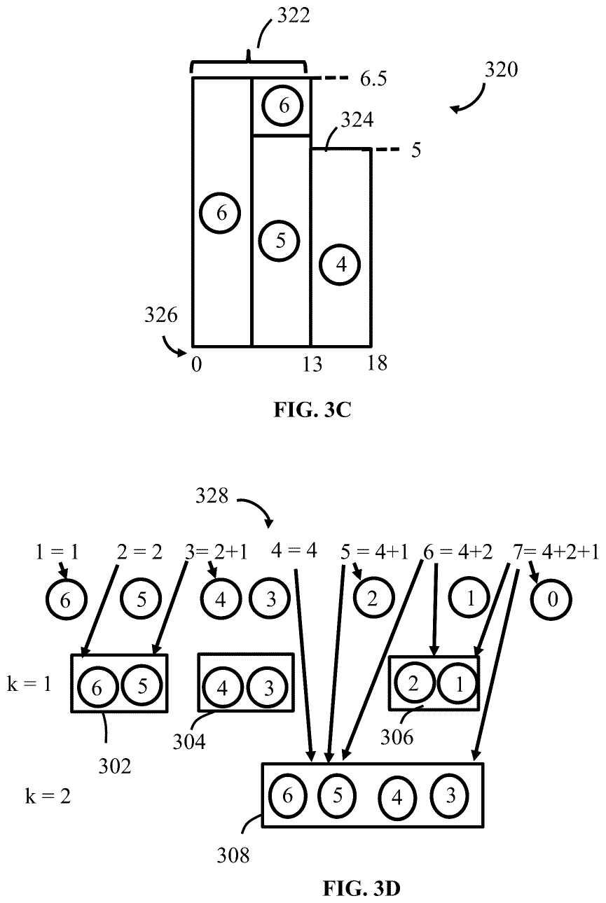

FIG. 3A schematically shows hierarchical grouping 300 of edges into trunks in accordance with an embodiment of the present disclosure. Although PAT may can dramatically reduce space consumption, it still has the

$$O ( log \frac{D}{trunkSize} )$$

time complexity. Some embodiments may use a hierarchical PAT (HPAT) to trade slightly more memory space for lower sampling complexity. For example, for each vertex u with the current edges set {e₁, . . . , eₙ}, there may be a trunk set τᵤ formed in accordance to Equation 1 as follows:

τᵤ={τᵤ⁰, . . . τᵤ^{k}, . . . τᵤ^{K}}, 0≤k≤K=└log₂(|N(u)|)┘ Equation 1

In the Equation 1, |N(u)| may be the total number of edges in the current edge set N(u). In the trunk set τᵤ, each element τᵤ^{k} may be formed in accordance to Equation 2 as follows:

$${τ}_{u}^{k} = \{ {τ}_{u}^{k , 0} , , … {τ}_{u}^{k , i} , … {τ}_{u}^{k , I} \} , 0 \leq i \leq I = ⌊ \frac{\vert N ( u ) \vert}{{2}^{k}} ⌋ - 1 \qquad Equation 2$$

Each trunk may be represented by an edge set of τᵤ^{k,i}={e_{i*2}_{^{k}}₊₁, . . . , e_{(i+1)*2}_{^{k}}, }. The edge set τᵤ^{k,i} may represent the i-th trunk of vertex u with the length of 2^{k}.

As shown in FIG. 3A, the current edge set for vertex 7 may be N(u)={6, . . . , 0} and the grouping 300 may include three levels of trunks for k=0, k=1 and k=2. For k=0, each edge may be a trunk at this level with the trunk size of 2⁰, and τᵤ⁰ may be {{6}, {5}, . . . {0}}. For k=1, two edges may form a multi-edge trunk at this level with the trunk size of 2¹, therefore, edges 6 and 5 may form a trunk 302, edges 4 and 3 may form a trunk 304, edges 2 and 1 may form a trunk 306, and τᵤ¹ may be {{6, 5}, {4, 3}, {2, 1}}. For k=2, four edges may form a multi-edge trunk at this level with the trunk size of 2², therefore, edges 6, 5, 4 and 3 may form a trunk 308, and τᵤ² may be {{6, 5, 4, 3}}.

FIG. 3B schematically shows a hierarchical persistent alias table (HPAT) 310 in accordance with an embodiment of the present disclosure. In preprocessing, an alias table may be generated for each trunk in the trunk set τᵤ. When sampling occurs, because the candidate edge set {e₁, . . . , eᵢ} must be the prefix of the current vertex's edge set {e₁, . . . , eₙ} with decreasing time, the candidate edge set may be divided into a number of trunks via binary decomposition. For vertex 7, for example, when the in edge is (8, 7, 0), the candidate edge set may include the edges {6, 5, 4, 3, 2, 1, 0} and may be divided into three trunks (e.g., 7=4+2+1): {g₁, g₂, g₃}. The HPAT 310 may include the alias tables 312, 314 and 316 and the prefix sum array 320. The first trunk g₁ may be the trunk 308 with four edges {6, 5, 4, 3} (e.g., g₁={6, 5, 4, 3}=τᵤ^{2,0}). The alias table 312 may be used to record the content of the trunk 308 and have four buckets with an average weight of 5.5. The second trunk g₂ may be the trunk 306 with two edges {4, 3} (e.g., g₂={2, 1}=τᵤ^{1,2}). The alias table 314 may be used to record the content of the trunk 306 and have two buckets with an average weight of 2.5. The third trunk g₃ may be the single edge {0} (e.g., g₃={0}=τᵤ^{0,6}). The alias table 316 may be used to record the content of this trunk with a single bucket of weight 1.

The probability of each trunk being sampled in a sampling process may be calculated by using the prefix sum array 318 [0, 22, 27, 28] as:

$$P ( {g}_{1} ) = ( 0 , \frac{C [ 4 ]}{C [ 7 ]} ] = ( 0 , 22 / 28 ] , \\ P ( {g}_{2} ) = ( \frac{C [ 4 ]}{C [ 7 ]} , \frac{C [ 6 ]}{C [ 7 ]} ] = ( 22 / 28 , 27 / 28 ] , \\ and P ( {g}_{3} ) = ( \frac{C [ 6 ]}{C [ 7 ]} , 1 ] = ( 27 / 28 , 1 ] .$$

An embodiment may first sample these trunks using ITS to choose a trunk of interest. After this, the alias table of the chosen trunk may be used to locally sample an edge (i.e., alias sampling applied here to enable fast sampling).

FIG. 3C schematically shows another hierarchical persistent alias table 320 in accordance with an embodiment of the present disclosure. For vertex 7, when the in edge is (9, 7, 4), the candidate edge set may include the edges {6, 5, 4} and may be divided into two trunks (e.g., 3=2+1). The HPAT 320 may include the alias tables 322 and 324 and the prefix sum array 326. The first trunk may be the trunk 302 with two edges {6, 5}. The alias table 322 may be used to record the content of the trunk 302 and have two buckets with an average weight of 6.5. The second trunk may be the single edge trunk (e.g., k=0) {4}. The alias table 324 may be used to record the content of this single edge trunk and have one bucket with an edge weight of 5. The probability of each trunk being sampled in a sampling process may be calculated by using the prefix sum array 326 [0, 13, 18]. An edge may be sampled similarly as sampling an edge using the HPAT 310. It should be noted that the second situation in PAT sampling may be avoided when HPAT is used because HPAT may include trunks with different lengths.

Using HPAT, the time complexity of ITS may be further reduced to O(log (log(D))) because there is up to log(D) trunks for each candidate edge set. After a trunk is chosen, the local processing using the alias table sampling within the sampled trunk only takes O(1) time complexity. In terms of space consumption, only the alias tables of the subsets of τᵤ^{k,i} need to be preprocessed, resulting in the space overhead of τᵤ^{k} as D and the overall space overhead for each vertex as low as Dlog(D) with D is the degree number. This is still much lower than simply applying the alias table sampling method which costs O(D²) for random walking on temporal graphs. Although HPAT may have a higher space overhead than ITS, which only needs D space, sampling using HPAT has a faster sampling speed.

It should be noted that if the temporal information of certain neighbors is earlier than all the incoming edges, these neighbors may be discarded from consideration. Moreover, if the out-degree of a vertex is relatively low, alias tables may be directly built for all its out edges.

FIG. 3D schematically shows a set of indices 328 in accordance with an embodiment of the present disclosure. Because the graph degree variance (maximum degree number) may be much smaller than the dataset size itself in most real-world graphs, the overhead of the trunk identification process for each candidate edge set may be further reduced by only preprocessing the binary decomposition from 1 to the degree variance (i.e., all possible lengths of the candidate edge sets). The set of indices 328 may include a plurality of indices for different valid edge sets. For example, if there is only one valid out edge, the length of the candidate edge set is 1, the index may be 1 and there may be one trunk having one edge (e.g., {{6}}); if there are two valid out edges, the length of the candidate edge set is 2, the index may be 2 and there may be one trunk having two edges (e.g., {{6, 5}}); if there are three valid out edges, the length of the candidate edge set is 3, the index may be a composite index 3 formed by two indices 2+1, and there may be two trunks (e.g., {{6, 5}, {4}}); if there are four valid out edges, the length of the candidate edge set is 4, the index may be 4 and there may be one trunk (e.g., {{6, 5, 4, 3}}); if there are five valid out edges, the length of the candidate edge set is 5, the index may be a composite index 5 formed by two indices 4+1 and there may be two trunks (e.g., {{6, 5, 4, 3}, {2}}); if there are six valid out edges, the length of the candidate edge set is 6, the index may be a composite index 6 formed by two indices 4+2 and there may be two trunks (e.g., {{6, 5, 4, 3}, {2, 1}}); and if there are seven valid out edges, the length of the candidate edge set is 7, the index may be a composite index 7 formed by three indices 4+2+1 and there may be three trunks (e.g., {{6, 5, 4, 3}, {2, 1}, {O}}).

The set of indices 328 may be referred to as auxiliary indices and may further reduce the time complexity from O(log(log(D))+log(D)) to O(log(log(D))) when using HPAT, where O(log(D)) is the time complexity for finding the valid trunks. Particularly, during sampling, both PAT and HPAT may need to find the trunks that contain the valid edges, i.e., Γₜ₍ᵤ₎. For example, when a walker arrives at vertex 7 from 0, the candidate edge set is Γₜ₌₃₍ᵤ₎={6, 5, 4, 3}. In this case, for PAT, the valid trunks may be {6, 5} and {4, 3}. For HPAT, the valid trunk may be {6, 5, 4, 3}. To further complicate this process, when a walker arrives at vertex 7 from vertex 9, the Γₜ₌₄₍ᵤ₎ would be {6, 5, 4}. In this case, the valid trunks in the hierarchical persistent alias method would be {6, 5} and {4}. In general, if a walker arrives at u at time t, the system may need to find the minimum number of trunks at sizes of 2ⁱ that can construct Γₜ₍ᵤ₎. This process needs log(|⊖ₜ₍ᵤ₎|) operations for decomposition and log(D) operations to find the valid trunks.

The auxiliary indices may be constructed for different lengths of valid edge sets by binary decomposition. That is, for an edge set of length L, represent L as a sum of minimum number of 2ⁱ. Because the trunks and alias tables of HPAT may be arranged into a complete binary search tree, for the vertex 7 with the in edge of (0, 7, 0) and the length of valid edge set by the composite index 7 (e.g., 4+2+1), the valid trunks may be located as follows. First, the first index 4 indicates the only size 4 trunk in the top-level (e.g., {6, 5, 4, 3}) should be fetched. Second, the second index of 2 indicates that the second valid trunk lies in the second level of the binary search tree. Then the position of the trunk starts from 4, which is the prefix sum of the size of the prior trunk. Finally, value 1 indicates that last valid trunk resides in the third level (e.g., k=0, where the trunk size is 1), and the position of the last valid trunk would be the prefix sum of the sizes of two already fetched trunks, that is, 4+2=6. Therefore, the last valid trunk may be obtained. The time complexity may be reduced from O(log(D)) to O(1) for finding the valid trunks.

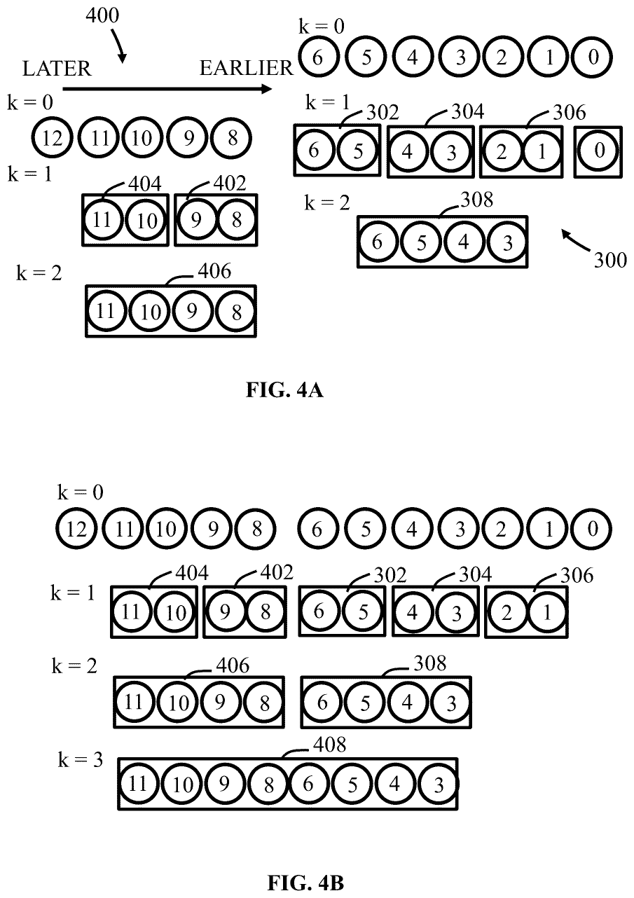

FIG. 4A schematically shows new edges being added to the candidate edge set of vertex 7 in accordance with an embodiment of the present disclosure. With increasing time, there may be more out edges from vertex 7 become valid out edges and added to the candidate edge set. As an example, edges 8, 9, 10, 11 and 12 may become valid edges and added to the candidate edge set. In some embodiments of streaming graph, the updates to a temporal graph may include addition of new edges and vertices, and the updates may be done in batches. For example, the new edges 8, 9, 10, 11 and 12 may be added as a batch to the existing out edges of vertex 7.

For each batch of new out edges, the PAT and HPAT and their indices corresponding to the grouping of the edges (e.g., trunks) may be updated. Because the PAT and HPAT may be built by the timing order of the edges (e.g., arranged by decreasing timing order) and new incoming edges in an update back all have their timing (e.g., timestamps) greater than the existing edges, these new edges may be appended to existing trunk grouping and corresponding PAT (and/or HPAT) may be updated accordingly with new trunks. That is, in at least one embodiment, the existing trunk grouping is not touched, hence the corresponding PAT and HPAT may be kept intact and the new edges may be grouped according to the timing order among themselves. For example, the new edges 8, 9, 10, 11 and 12 may be form an update edge set {8, 9, 10, 11, 12} and the grouping 400 may include three levels of trunks for k=0, k=1 and k=2. For k=0, each new out edge may be a trunk at this level with the trunk size of 2⁰ with 5 trunks at this level {{8}, {9}, {10}, {11}, {12}}. For k=1, two edges may form a trunk at this level with the trunk size of 2¹, therefore, edges 8 and 9 may form a multi-edge trunk 402 (e.g., {9, 8}), edges 10 and 11 may form a multi-edge trunk 404 (e.g., {11, 10}). For k=2, four edges may form a trunk at this level with the trunk size of 2², therefore, edges 11, 10, 9 and 8 may form a multi-edge trunk 406 (e.g., {11, 10, 9, 8}).

It should be noted that for the update edge set, the grouping may start by forming trunks by starting from the earliest edge. That is, trunks may be formed by edges in increasing time order. For example, edges may be ordered by increasing time order as {8, 9, 10, 11, 12} and trunks may be formed. This way, edge 12 may be left out in both level k=1 and level k=2 trunks, compared to edge 0 being left out in grouping 300. Moreover, FIG. 4A shows an updated edge set in hierarchical grouping for HPAT, grouping for PAT may be similarly performed in at least one embodiment that uses PAT instead of HPAT.

FIG. 4B schematically shows a new trunk in a higher order of a hierarchy with new edges added to the candidate edge set in accordance with an embodiment of the present disclosure. With the new edges added, the candidate edge set may have enough edges to form a next level trunk (e.g., trunk length of a higher power of 2). That is, the new edges may lead to the growth of the hierarchy of HPAT with a level k=3 multi-edge trunk 408 {3, 4, 5, 6, 8, 9, 10, 11} being formed.

Some embodiments may perform graph computation in an out-of-core mode, in which portions of the graph may be swapped in and out of the memory as needed during operation. Because the updated trunk grouping may have a higher hierarchy, even under the out-of-core mode, the newly created HPAT(s) may be stored sequentially following current HPATs.

The grouping of edges into trunks may lead to PAT and HPAT being built. The set of auxiliary indices may also be built based on the candidate edge set. In some embodiments, in a random walk computing task, an active walker may arrive an active vertex. The corresponding auxiliary indices may be access based on the active vertex, and the index (or composite index) may be used to locate the corresponding PAT or HPAT, a trunk may be chosen based on sampling using PAT or HPAT, and an edge may be selected from the trunk. This process continues until the convergence (i.e., arriving at the random walk length). Pseudo code to implement a Sampling function may be as follows:

```
function Sampling(Random &R, Vertex &u, Time &t)
  Candidate edge set L =┌ₜ₍ᵤ₎
  Trunks set L′ = Auxiliary_Index(L)
  Sampled trunk index (k,i) = Sampling R on L′ by ITS
  return Edge = Sampling R on the trunk τᵤ^{k,i} alias method
end function
```

In some embodiments, a temporal-centric framework may be provided to the end-users to express temporal random walk algorithms with ease. And a computing system may generate or output the sampled path at the end. The time instance may affect the core of random walk, that is, probability distribution. This framework may need two user involvements, i.e., parameters and APIs. Pseudo code to perform a random walk computing task may be as follows:

```
E′ = Edges_interval( E, start_time, end_time )
Preprocess(E′, Dynamic_weight( ))
while Len>0 do
  for each random walk S do
    (u, t) = S.current_vertex
    (up , tp ) = S.previous_vertex
    while True do
      R = random( )
      (u, v, t′) = Sampling(R, u, t)
      if Accept(R, Dynamic_parameter(up , v)) then
        break
      end if
    end while
    S.previous_vertex = (u, t)
    S.current_vertex = (v, t′)
  end for
  Len = Len−1
end while
```

In the pseudo code for performing a random walk computation process, parameters (e.g., Dynamic_weight and Dynamic_parameter) may be offered for users to give simple bias according to different applications. APIs may provide more expressiveness to users, i.e., (Edges_interval). For example, Edges_interval may allow users to generate random walks on subgraphs which are fully defined by users according to applications.

The pseudo code for random walk process shows how user APIs may interact with the framework. Particularly, Edges_interval may be used to get the subgraph for each query. Then Preprocess function may be used to generate the alias tables and auxiliary index. During the random walk, Sampling function uses HPAT to encode Dynamic_weight. The Accept function uses the rejection sampling to deal with dynamic parameters of random walks provided by Dynamic_parameter (e.g., p and q in temporal node2vec). For random walks without dynamic parameters, “Accepted” may be returned during each sampling process. Finally, the process may update random walks by newly sampled edges.

In various embodiments, the PAT and HPAT design may be well suited for external memory random walk. Under this context, the preprocessed data (i.e., alias tables and prefix-sum of edges inside each trunk) may be partitioned and stored in non-volatile storage disks (e.g., solid state drives (SSDs)), while the prefix-sum of edge trunks may be stored in the main memory for direct sampling which only consumes

$$\frac{\vert E \vert}{trunkSize}$$

space (E is the edge set). Therefore, the ITS method may be applied to rapidly choose the trunk of interest by sampling the trunks. For the streaming graph support, the incremental update can incrementally create new PATs or HPATs for new arrival edges and store the created index in the disk.

A computing system using the PAT and HPAT for sampling may need to perform the following three operations: (1) searching the candidate edge set for each edge (reducing time limits), (2) constructing alias tables for each vertex, and (3) generating the auxiliary index for the HPATs. In at least one embodiment, the three operations may be performed in parallel.

With respect to candidate edge sets construction, when the current random walk arrives at edge (u, v, t), it needs to find the candidate edge set Γt (v), which may be the out-edges that are later than the time t of edge (u, v, t). The candidate edge sets for all in-edges may be constructed in parallel in two steps. First, the out-edges of the same source vertex may be sorted in time decreasing order. Second, a binary search may be performed on the sorted out-edge list to decide the candidate edge set for each in-edge. Both steps may be conducted in parallel.

For PAT/HPAT construction, HPAT construction may be used as an example, and the PAT may be constructed similarly. To provide a lock-free parallel for this construction process, the data competition may be decoupled in memory. The position of each alias table (τᵤ^{k}) may be calculated in memory. Because the length of each alias table is fixed (e.g., 2^{k}), the position may be calculated before constructing the alias table. With the derived position, a thread may be initiated and assigned to construct an alias table and store the constructed alias table in the designated memory position without contention.

As for auxiliary index generation, the auxiliary index may be constructed for HPAT sampling on each candidate edge set Γt (u). Because the size of Γt (u) is up to the degree size of the vertex u, the binary decomposition of each degree size from 1 to D may be generated and stored as the auxiliary index, in which D may be the maximum degree of the whole graph. Therefore, the auxiliary index construction may take Σ_{D′=1}^{D}=log (D′) time. For most traditional graphs, the maximum degree D may be up to millions, which leads to the acceptable auxiliary index construction time. Additionally, the binary decomposition of different degree numbers is independent. Therefore, the auxiliary index construction may be embarrassingly slow but can be performed in parallel for different degree numbers.

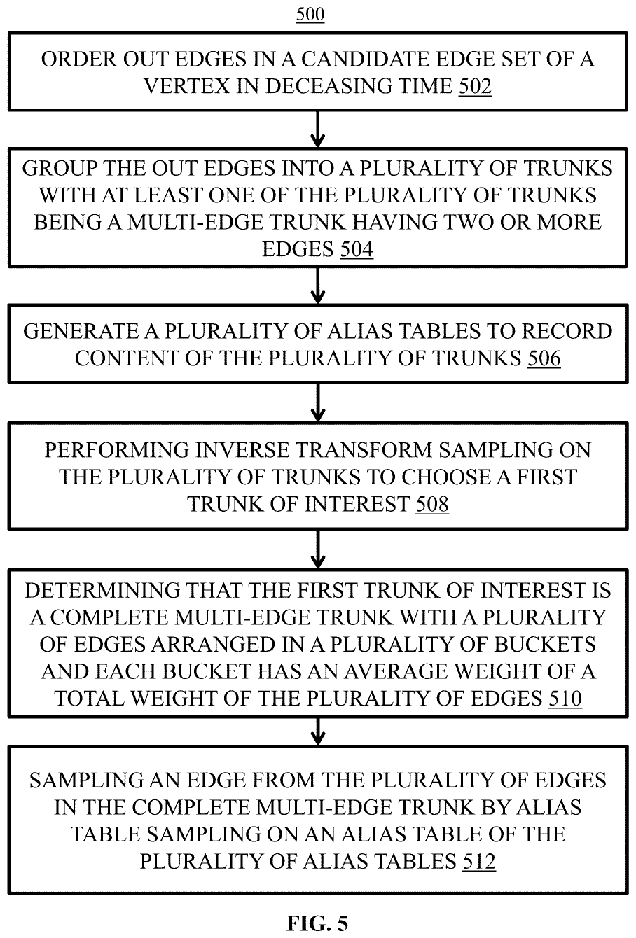

FIG. 5 shows a flow chart for a process 500 to provide a temporal graph computing solution in accordance with an embodiment of the present disclosure. The process 500 may perform a transformation on an input temporal graph and an execution on the transformed temporal graph provide a temporal graph computing solution in accordance with an embodiment of the present disclosure. At block 502, out edges in a candidate edge set of a vertex may be ordered in deceasing time. At block 504, the out edges may be grouped into a plurality of trunks with at least one of the plurality of trunks being a multi-edge trunk having two or more edges. For example, the out edges for the vertex 7 may be ordered in decreasing time and grouped into a plurality of trunks (e.g., FIG. 2A, or trunk set in FIG. 3A that includes valid trunks for different in edges).

At block 506, generating a plurality of alias tables to record content of the plurality of trunks. For example, alias tables, such as PAT 200 and HPAT 310 may be generated to record content of the plurality of trunks. At block 508, inverse transform sampling may be performed on the plurality of trunks to choose a first trunk of interest. For example, a random number in the range of zero to the total weight of the out edges may be generated and the trunk that has the weight range including the random number may be selected as the chosen trunk of interest.

At block 510, the first trunk of interest may be determined to be a complete multi-edge trunk with a plurality of edges arranged in a plurality of buckets and each bucket has an average weight of a total weight of the plurality of edges. And at block 512, an edge may be sampled from the plurality of edges in the complete multi-edge trunk by alias table sampling on an alias table of the plurality of alias tables corresponding to the first trunk of interest. For example, in the case of PAT, when the chosen trunk of interest is a complete trunk that has a plurality of buckets each having an average weigh of the total weight of the trunk, an edge in the trunk may be sampled by alias table sampling. In the case of HPAT, for any trunk of k=1 or higher to be as the trunk of interest, it would be a complete trunk by the nature of binary decomposition and an edge in the trunk may be sampled by alias table sampling as well.

In some embodiments, the process 500 may be implemented in software instructions, and the software instructions may be executed by one or more computer processors to carry out the respective operations of the process 500.

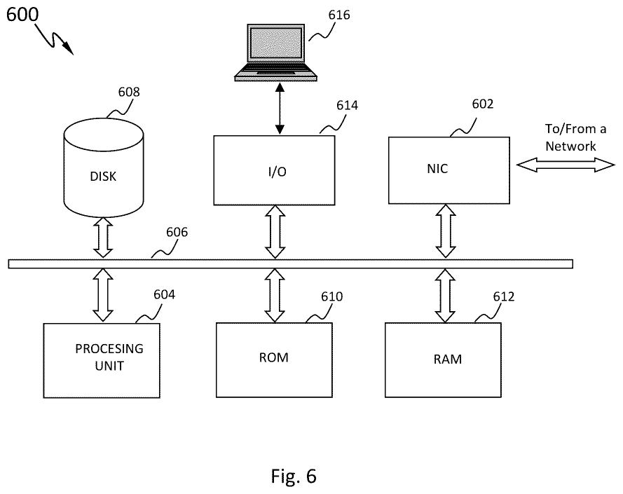

FIG. 6 is a functional block diagram illustration for a computing device 600 on which the present teaching may be implemented. The computing device 600 may be a general-purpose computer or a special purpose computer or a blade in a rack of a data center, including but not limited to, a personal computer, a laptop, a server computer, a tablet, a smartphone. The methods and operations as described herein may each be implemented on one or more embodiments of the computing device 600, via hardware, software program, firmware, or a combination thereof.

The computing device 600, for example, may include one or more NICs 602 connected to and from a network to facilitate data communications. The computing device 600 may also include a processing unit 604. In an embodiment, the processing unit 604 may include a central processing unit (CPU), for example, in the form of one or more processors (e.g., single core or multi-core), for executing software instructions. In an embodiment, the CPU may be optional for the processing unit 604, but the processing unit 604 may comprise other processing units, for example, but not limited to, a Graphics Processing Unit (GPU), an ASIC, or one or more of both. It should be noted that the operations and processes described herein may be performed by a CPU, a GPU, an ASIC, other circuitry or combination of the processing units and circuitry.

The exemplary computer device 600 may further include an internal communication bus 606, program storage and data storage of different forms, e.g., an out-of-core storage such as the non-volatile storage 608 (e.g., conventional hard drive, or a solid state drive), read only memory (ROM) 610, and a main memory such as the random access memory (RAM) 612, for various data files to be processed and/or communicated by the computer, as well as software instructions to be executed by the CPU 604. The computing device 600 may also include an I/O component 614, supporting input/output flows between the computer and other components therein such as user interface elements 616 (which may be optional in a data center for a server machine). The computing device 600 may also receive software program and data via network communications.

In various embodiments, the PAT sampling and HPAT sampling may partition the candidate edge set into different trunks. Then, the ITS sampling may be used to choose the trunk of interest. Finally, because each trunk is static, alias table sampling may be used to sample an edge.

PAT contains both new data structures and unique sampling approach to allow efficient sampling with a dynamic edge set. Alias tables and prefix sum array may be needed for the data structure. For construction of trunks using PAT, the entire neighbor list of each vertex may be separated into a collection of trunks with each of them containing an equal number of edges. In some embodiments, HPAT may be used. For HPAT, a hierarchy of trunks may be generated to form a trunk set for a vertex. Each trunk in the trunk set may have a 2ⁱ number of edges, with i being an integer value from zero to less than or equal to log(D), in which D may be a degree of out edges of the vertex.

Embodiments of the present disclosure may achieve low space consumption, fast sampling speed, and expressive programming interfaces for various temporal random walk applications. A novel hybrid sampling method is provided, which may combine ITS and alias method to drastically reduce space complexity and achieve high sampling speed. This method removes the dependency of edge transition probability calculation on the walker's temporal information and takes advantage of both the ITS and the alias sampling methods by averting the expensive searching cost in ITS and the enormous space overhead in the alias method.

Moreover, the sampling space may be stored in a Persistent Alias Table (PAT) data structure. In at least one embodiment, the PAT may be implemented by a Hierarchical Persistent Alias Table (HPAT), associated with an auxiliary index, to dramatically improve the sampling efficiency, and enable out-of-core sampling for large temporal graphs. Additionally, efficient streaming graph processing support is provided. As for programming, high-level user-friendly APIs and customized function design options may be provided to improve user productivity.

Embodiments according to the present disclosure may be applied to biased temporal random walk applications, such as, but not limited to, linear temporal weight random walk, exponential temporal weight random walk and temporal node2vec. Moreover, embodiments may also be applied to unbiased edge weight random walk applications that may assign uniform weight to all edges.

In an exemplary embodiment, there is provided a method for performing temporal graph computing that may comprise ordering out edges in a candidate edge set of a vertex in deceasing time, grouping the out edges into a plurality of trunks with at least one of the plurality of trunks being a multi-edge trunk having two or more edges, generating a plurality of alias tables to record content of the plurality of trunks, performing inverse transform sampling on the plurality of trunks to choose a first trunk of interest, determining that the first trunk of interest is a complete multi-edge trunk with a plurality of edges arranged in a plurality of buckets and sampling an edge from the plurality of edges in the complete multi-edge trunk by alias table sampling on an alias table of the plurality of alias tables corresponding to the first trunk of interest. Each bucket may have an average weight of a total weight of the plurality of edges.

In an embodiment, the method may further comprise performing inverse transform sampling on the plurality of trunks to choose a second a trunk of interest, determining that the second trunk of interest is an incomplete trunk with one or more edges arranged in one or more buckets, calculating a prefix sum for the one or more edges in the incomplete trunk and sampling an edge from the one or more edges in the incomplete trunk by inverse transform sampling.

In an embodiment, the plurality of trunks may be selected from a trunk set generated by preprocessing the preprocessing the candidate edge, the trunk set may contain a hierarchy of trunks with trunk lengths being 2ⁱ, with i being integer values greater than or equal to 0 and less than or equal to log(D), D being a maximum degree of the vertex.

In an embodiment, the plurality of trunks may be a minimum number of trunks selected from the trunk set with each of the out edges in a candidate edge set being included in only one of the plurality of trunks.

In an embodiment, the method may further comprise preprocessing all out edges of the vertex to build a set of indices by binary decomposition to cover all possible lengths of various candidate sets of the vertex, and selecting the plurality of trunks from the trunk set by selecting an index from the set of indices based on a length of the candidate edge set.

In an embodiment, the method may further comprise receiving a batch of new out edges, ordering the new out edges in increasing time, grouping the new out edges into a plurality of new trunks in an incremental hierarchy and appending the incremental hierarchy to the hierarchy of trunks.

In an embodiment, the method may further comprise forming a new trunk of a higher power of 2 in the trunk set by combining one or more new out edges with one or more out edges of the candidate edge set.

In another exemplary embodiment, there is provided a computing system that may comprise a main memory for storing software instructions for performing temporal graph computing and a central processing unit (CPU) coupled to the main memory and configured to execute the software instructions to: order out edges in a candidate edge set of a vertex in deceasing time, group the out edges into a plurality of trunks with at least one of the plurality of trunks being a multi-edge trunk having two or more edges, generate a plurality of alias tables to record content of the plurality of trunks, perform inverse transform sampling on the plurality of trunks to choose a first trunk of interest, determine that the first trunk of interest is a complete multi-edge trunk with a plurality of edges arranged in a plurality of buckets and each bucket has an average weight of a total weight of the plurality of edges, and sample an edge from the plurality of edges in the complete multi-edge trunk by alias table sampling on an alias table of the plurality of alias tables corresponding to the first trunk of interest.

In an embodiment, the CPU executing the software instructions may be further configured to: perform inverse transform sampling on the plurality of trunks to choose a second a trunk of interest, determine that the second trunk of interest is an incomplete trunk with one or more edges arranged in one or more buckets, calculate a prefix sum for the one or more edges in the incomplete trunk, and sample an edge from the one or more edges in the incomplete trunk by inverse transform sampling.

In an embodiment, the plurality of trunks may be selected from a trunk set generated by preprocessing the preprocessing the candidate edge, the trunk set may contain a hierarchy of trunks with trunk lengths being 2ⁱ, with i being integer values greater than or equal to 0 and less than or equal to log(D), D being a maximum degree of the vertex.

In an embodiment, the plurality of trunks may be a minimum number of trunks selected from the trunk set with each of the out edges in a candidate edge set being included in only one of the plurality of trunks.

In an embodiment, the CPU executing the software instructions may be further configured to: preprocess all out edges of the vertex to build a set of indices by binary decomposition to cover all possible lengths of various candidate sets of the vertex; and select the plurality of trunks from the trunk set by selecting an index from the set of indices based on a length of the candidate edge set.

In an embodiment, the CPU executing the software instructions may be further configured to: receive a batch of new out edges, order the new out edges in increasing time, group the new out edges into a plurality of new trunks in an incremental hierarchy, and append the incremental hierarchy to the hierarchy of trunks.

In an embodiment, the CPU executing the software instructions may be further configured to: form a new trunk of a higher power of 2 in the trunk set by combining one or more new out edges with one or more out edges of the candidate edge set.

In yet another exemplary embodiment, there is provided one or more computer-readable non-transitory media comprising one or more instructions that when executed by one or more processors is to configure the one or more processors to perform operations comprising: ordering out edges in a candidate edge set of a vertex in deceasing time, grouping the out edges into a plurality of trunks with at least one of the plurality of trunks being a multi-edge trunk having two or more edges, generating a plurality of alias tables to record content of the plurality of trunks, performing inverse transform sampling on the plurality of trunks to choose a first trunk of interest, determining that the first trunk of interest is a complete multi-edge trunk with a plurality of edges arranged in a plurality of buckets and each bucket has an average weight of a total weight of the plurality of edges, and sampling an edge from the plurality of edges in the complete multi-edge trunk by alias table sampling on an alias table of the plurality of alias tables corresponding to the first trunk of interest.

In an embodiment, the computer-readable non-transitory media may further comprise one or more software instructions that when executed by the one or more processors is to configure the one or more processors to cause further performance of temporal graph operations comprising: performing inverse transform sampling on the plurality of trunks to choose a second a trunk of interest, determining that the second trunk of interest is an incomplete trunk with one or more edges arranged in one or more buckets, calculating a prefix sum for the one or more edges in the incomplete trunk, and sampling an edge from the one or more edges in the incomplete trunk by inverse transform sampling.

In an embodiment, the plurality of trunks may be selected from a trunk set generated by preprocessing the preprocessing the candidate edge, the trunk set may contain a hierarchy of trunks with trunk lengths being 2ⁱ, with i being integer values greater than or equal to 0 and less than or equal to log(D), D being a maximum degree of the vertex.

In an embodiment, the plurality of trunks may be a minimum number of trunks selected from the trunk set with each of the out edges in a candidate edge set being included in only one of the plurality of trunks.

In an embodiment, the computer-readable non-transitory media may further comprise one or more software instructions that when executed by the one or more processors is to configure the one or more processors to cause further performance of temporal graph operations comprising: preprocessing all out edges of the vertex to build a set of indices by binary decomposition to cover all possible lengths of various candidate sets of the vertex, and selecting the plurality of trunks from the trunk set by selecting an index from the set of indices based on a length of the candidate edge set.

In an embodiment, the computer-readable non-transitory media may further comprise one or more software instructions that when executed by the one or more processors is to configure the one or more processors to cause further performance of temporal graph operations comprising: receiving a batch of new out edges, ordering the new out edges in increasing time, grouping the new out edges into a plurality of new trunks in an incremental hierarchy, appending the incremental hierarchy to the hierarchy of trunks, and forming a new trunk of a higher power of 2 in the trunk set by combining one or more new out edges with one or more out edges of the candidate edge set.

Hence, aspects of the system and method for temporal graph computing, as outlined above, may be embodied in programming (e.g., software instructions). Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the computer-implemented method.

All or portions of the computer-implemented method may at times be communicated through a network such as the Internet or various other telecommunication networks. Such communications, for example, may enable loading of the software from one computer or processor into another. Thus, another type of media that may bear the elements of the computer-implemented method includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the computer-implemented method. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-transitory storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing description and drawings represent embodiments of the present teaching, it will be understood that various additions, modifications, and substitutions may be made therein without departing from the spirit and scope of the principles of the present teaching as defined in the accompanying claims. One skilled in the art will appreciate that the present teaching may be used with many modifications of form, structure, arrangement, proportions, materials, elements, and components and otherwise, used in the practice of the disclosure, which are particularly adapted to specific environments and operative requirements without departing from the principles of the present teaching. For example, although the implementation of various components described above may be embodied in a hardware device, it can also be implemented as a firmware, firmware/software combination, firmware/hardware combination, or a hardware/firmware/software combination. The presently disclosed embodiments are therefore to be considered in all respects as illustrative and not restrictive, the scope of the present teaching being indicated by the following claims and their legal equivalents, and not limited to the foregoing description.

What is claimed is:

1. A method for performing temporal graph computing, comprising:
ordering out edges in a candidate edge set of a vertex in deceasing time;
grouping the out edges into a plurality of trunks with at least one of the plurality of trunks being a multi-edge trunk having two or more edges;
generating a plurality of alias tables to record content of the plurality of trunks;
performing inverse transform sampling on the plurality of trunks to choose a first trunk of interest;
determining that the first trunk of interest is a complete multi-edge trunk with a plurality of edges arranged in a plurality of buckets and each bucket has an average weight of a total weight of the plurality of edges; and
sampling an edge from the plurality of edges in the complete multi-edge trunk by alias table sampling on an alias table of the plurality of alias tables corresponding to the first trunk of interest.

2. The method of claim 1, further comprising:
performing inverse transform sampling on the plurality of trunks to choose a second a trunk of interest;
determining that the second trunk of interest is an incomplete trunk with one or more edges arranged in one or more buckets;
calculating a prefix sum for the one or more edges in the incomplete trunk; and
sampling an edge from the one or more edges in the incomplete trunk by inverse transform sampling.

3. The method of claim 1, wherein the plurality of trunks are selected from a trunk set generated by preprocessing the preprocessing the candidate edge, the trunk set contains a hierarchy of trunks with trunk lengths being 2ⁱ, with i being integer values greater than or equal to 0 and less than or equal to log(D), D being a maximum degree of the vertex.

4. The method of claim 3, wherein the plurality of trunks are a minimum number of trunks selected from the trunk set with each of the out edges in a candidate edge set being included in only one of the plurality of trunks.

5. The method of claim 4, further comprising:
preprocessing all out edges of the vertex to build a set of indices by binary decomposition to cover all possible lengths of various candidate sets of the vertex; and
selecting the plurality of trunks from the trunk set by selecting an index from the set of indices based on a length of the candidate edge set.

6. The method of claim 3, further comprising:
receiving a batch of new out edges;
ordering the new out edges in increasing time;
grouping the new out edges into a plurality of new trunks in an incremental hierarchy; and
appending the incremental hierarchy to the hierarchy of trunks.

7. The method of claim 6, further comprising: forming a new trunk of a higher power of 2 in the trunk set by combining one or more new out edges with one or more out edges of the candidate edge set.

8. A computing system, comprising:
a main memory for storing software instructions for performing temporal graph computing; and
a central processing unit (CPU) coupled to the main memory and configured to execute the software instructions to:
order out edges in a candidate edge set of a vertex in deceasing time;
group the out edges into a plurality of trunks with at least one of the plurality of trunks being a multi-edge trunk having two or more edges;
generate a plurality of alias tables to record content of the plurality of trunks;
perform inverse transform sampling on the plurality of trunks to choose a first trunk of interest;
determine that the first trunk of interest is a complete multi-edge trunk with a plurality of edges arranged in a plurality of buckets and each bucket has an average weight of a total weight of the plurality of edges; and
sample an edge from the plurality of edges in the complete multi-edge trunk by alias table sampling on an alias table of the plurality of alias tables corresponding to the first trunk of interest.

9. The computing system of claim 8, wherein the CPU executing the software instructions is further configured to:
perform inverse transform sampling on the plurality of trunks to choose a second a trunk of interest;
determine that the second trunk of interest is an incomplete trunk with one or more edges arranged in one or more buckets;
calculate a prefix sum for the one or more edges in the incomplete trunk; and
sample an edge from the one or more edges in the incomplete trunk by inverse transform sampling.

10. The computing system of claim 8, wherein the plurality of trunks are selected from a trunk set generated by preprocessing the preprocessing the candidate edge, the trunk set contains a hierarchy of trunks with trunk lengths being 2ⁱ, with i being integer values greater than or equal to 0 and less than or equal to log(D), D being a maximum degree of the vertex.

11. The computing system of claim 10, wherein the plurality of trunks are a minimum number of trunks selected from the trunk set with each of the out edges in a candidate edge set being included in only one of the plurality of trunks.

12. The computing system of claim 11, wherein the CPU executing the software instructions is further configured to:
preprocess all out edges of the vertex to build a set of indices by binary decomposition to cover all possible lengths of various candidate sets of the vertex; and
select the plurality of trunks from the trunk set by selecting an index from the set of indices based on a length of the candidate edge set.

13. The computing system of claim 10, wherein the CPU executing the software instructions is further configured to:
receive a batch of new out edges;
order the new out edges in increasing time;
group the new out edges into a plurality of new trunks in an incremental hierarchy; and
append the incremental hierarchy to the hierarchy of trunks.

14. The computing system of claim 13, wherein the CPU executing the software instructions is further configured to: form a new trunk of a higher power of 2 in the trunk set by combining one or more new out edges with one or more out edges of the candidate edge set.

15. One or more computer-readable non-transitory media comprising one or more software instructions that when executed by one or more processors is to configure the one or more processors to cause performance of temporal graph operations comprising:
ordering out edges in a candidate edge set of a vertex in deceasing time;
grouping the out edges into a plurality of trunks with at least one of the plurality of trunks being a multi-edge trunk having two or more edges;
generating a plurality of alias tables to record content of the plurality of trunks;
performing inverse transform sampling on the plurality of trunks to choose a first trunk of interest;
determining that the first trunk of interest is a complete multi-edge trunk with a plurality of edges arranged in a plurality of buckets and each bucket has an average weight of a total weight of the plurality of edges; and
sampling an edge from the plurality of edges in the complete multi-edge trunk by alias table sampling on an alias table of the plurality of alias tables corresponding to the first trunk of interest.

16. The computer-readable non-transitory media of claim 15, further comprising one or more software instructions that when executed by the one or more processors is to configure the one or more processors to cause further performance of temporal graph operations comprising:
performing inverse transform sampling on the plurality of trunks to choose a second a trunk of interest;
determining that the second trunk of interest is an incomplete trunk with one or more edges arranged in one or more buckets;
calculating a prefix sum for the one or more edges in the incomplete trunk; and
sampling an edge from the one or more edges in the incomplete trunk by inverse transform sampling.

17. The computer-readable non-transitory media of claim 15, wherein the plurality of trunks are selected from a trunk set generated by preprocessing the preprocessing the candidate edge, the trunk set contains a hierarchy of trunks with trunk lengths being 2ⁱ, with i being integer values greater than or equal to 0 and less than or equal to log(D), D being a maximum degree of the vertex.

18. The computer-readable non-transitory media of claim 17, wherein the plurality of trunks are a minimum number of trunks selected from the trunk set with each of the out edges in a candidate edge set being included in only one of the plurality of trunks.

19. The computer-readable non-transitory media of claim 18, further comprising one or more software instructions that when executed by the one or more processors is to configure the one or more processors to cause further performance of temporal graph operations comprising:
preprocessing all out edges of the vertex to build a set of indices by binary decomposition to cover all possible lengths of various candidate sets of the vertex; and
selecting the plurality of trunks from the trunk set by selecting an index from the set of indices based on a length of the candidate edge set.

20. The computer-readable non-transitory media of claim 17, further comprising one or more software instructions that when executed by the one or more processors is to configure the one or more processors to cause further performance of temporal graph operations comprising:
receiving a batch of new out edges;
ordering the new out edges in increasing time;
grouping the new out edges into a plurality of new trunks in an incremental hierarchy;
appending the incremental hierarchy to the hierarchy of trunks; and
forming a new trunk of a higher power of 2 in the trunk set by combining one or more new out edges with one or more out edges of the candidate edge set.
